(19) United States
(12) Patent Application Publication
(10) Pub. No.: US 2021/0034173 A1
(43) Pub. Date: Feb. 4, 2021

(54) Active Stylus and Method of Generating Wireless Signals Thereof

(71) Applicant: Syncore Technology Co., Ltd., Taipei City (TW)

(72) Inventors: Ching-Yu Chou, Taipei City (TW); Han-Pin Jeng, Taipei City (TW)

(21) Appl. No.: 16/525,659

(22) Filed: Jul. 30, 2019

(51) Int. Cl. G06F 3/0354; G06F 3/038

(52) U.S. Cl. CPC G06F 3/03545; G06F 2203/0384; G06F 3/0383

(57) ABSTRACT

An active stylus and a method of generating wireless signals thereof are described. After the active stylus sends a first beacon signal, it determines whether to generate a first or second button signal. When the first and second button signals are both generated, the active stylus generates a first button transmission signal according to a first frequency, generates a second button transmission signal according to a second frequency, and sends out the first and second button transmission signals. Since the frequencies of the first and second button transmission signals are different, the simultaneously sent first and second button transmission signals can be separated by filtering or Fourier transform when a receiving end receives the first and second button send transmission signals. In this way, the overall time for transmitting the first and second button transmission signals can be shortened, thereby quickly transmitting the wireless signals.

### BACKGROUND OF THE INVENTION

### 1. Field of the Invention

The invention relates to a stylus and a method of generating wireless signals and, in particular, to an active stylus and a method of generating wireless signals thereof.

### 2. Description of Related Art

A general active stylus wirelessly transmits wireless signals to a tablet computer or a smart phone for wireless communications in a wireless way, so that the tablet computer or the smart phone can determine the user's operations with the active stylus. For example, the user can press a button provided on the active stylus to perform a specific operation, such as page up or page down.

The wireless signal transmission method of the existing wireless communication technology generally transmits various kinds of information in batches in a time-sequential manner by means of time division multiplexing. For example, a transmitting end sends a wireless signal with the initialization information in the beginning, signaling that the subsequent wireless signals contain various kinds of information. Afterwards, a wireless signal containing first information is sent out. When the transmission of the wireless signal with the first information is completed and after some time interval, a wireless signal containing second information is sent out. Such a process continues until all information is sent. Finally, a wireless signal containing ending information is sent out, indicating that the information is completely transmitted. This forms a transmission period.

A receiving end continuously receives the wireless signals. When the received wireless signal is determined to contain the initialization information, it represents that the subsequent wireless signals contain various kinds of information. Moreover, the time interval of the initialization information can be used to derive the various kinds of information in the wireless signals. For example, immediately after the initialization information is the first information, then the second information, and so on. In this way, the transmitting end and the receiving end can communicate via the wireless signals.

However, the wireless signal transmission method of the existing wireless communication technology is slow in transmitting a large amount of data. When the data is huge, each piece of data takes a considerable amount of time to be transmitted. Therefore, the existing method of wireless signal transmissions needs to be further improved.

### SUMMARY OF THE INVENTION

In view of foregoing, the invention provides a wireless signal generating method for an active stylus that can send out wireless signal rapidly. The wireless signal generating method of the active stylus is performed using an active stylus and includes the following steps:
generating and transmitting a first beacon signal;
waiting for a first time interval;
determining whether a first button signal or a second button signal is generated;
when it is determined that the first button signal and the second button signal are generated, generating a first button transmission signal using a first frequency and generating a second button transmission signal using a second frequency, and transmitting the first button transmission signal and the second button transmission signal.

The active stylus includes a first button unit, a second button unit, a wireless signal transmitting unit, and a processing unit. The first button unit is configured to generate a first button signal. The second button unit is configured to generate a second button signal.

The processing unit is electrically connected to the first button unit, the second button unit, and the wireless signal transmitting unit. The processing unit generates a first beacon signal, and sends the first beacon signal via the wireless signal transmitting unit.

After the processing unit sends the first beacon signal, the processing unit waits for the first time interval, and determines whether the first button signal generated by the first button unit or the second button signal generated by the second button unit is received.

When the processing unit receives the first button signal and the second button signal, the processing unit sends a composite signal, which includes the first button transmission signal of the first frequency and the second button transmission signal of the second frequency.

The active stylus and the method of generating wireless signals thereof make use of the composite signal that includes the first button transmission signal generated at the first frequency and the second button transmission signal generated at the second frequency, and send the composite signal. After a receiving end, such as a tablet computer, receives the composite signal, the simultaneously sent first button transmission signal and second button transmission signal can be separated by filtering or Fourier transform because the first button transmission signal and the second button transmission signal are generated at different frequencies. Then the corresponding function is performed according to the first button transmission signal and the second button transmission signal.

Therefore, even if the first button transmission signal and the second button transmission signal are simultaneously sent, the receiving end can separate the first button transmission signal and the second button transmission signal. Since the first button transmission signal and the second button transmission signal are simultaneously sent, instead of being sent at different times, the invention can further shorten the overall transmitting time for sending the first button transmission signal and the second button transmission signal. Therefore, the wireless signals can be rapidly transmitted.

### BRIEF DESCRIPTION OF THE DRAWINGS

FIG. 1 is a schematic flow chart of a first preferred embodiment method of generating wireless signals of an active stylus according to the invention;

FIG. 2 and FIG. 3 are schematic views of the waveforms of wireless signals generated according to the wireless signal generating method of the active stylus;

FIG. 4 and FIG. 5 are schematic flow charts of a second preferred embodiment method of generating wireless signals of an active stylus according to the invention;

FIG. 6 is a schematic view of the waveforms of wireless signals generated according to the wireless signal generating method of the active stylus;

FIG. 7 is a schematic flow chart of a third preferred embodiment method of generating wireless signals of an active stylus according to the invention;

FIG. 8 is a schematic view of the waveforms of wireless signals generated according to the wireless signal generating method of the active stylus;

FIG. 9 is a schematic flow chart of a fourth preferred embodiment method of generating wireless signals of an active stylus according to the invention; and

FIG. 10 is a block diagram showing a preferred embodiment of the active stylus.

### DETAILED DESCRIPTION OF THE PREFERRED EMBODIMENT

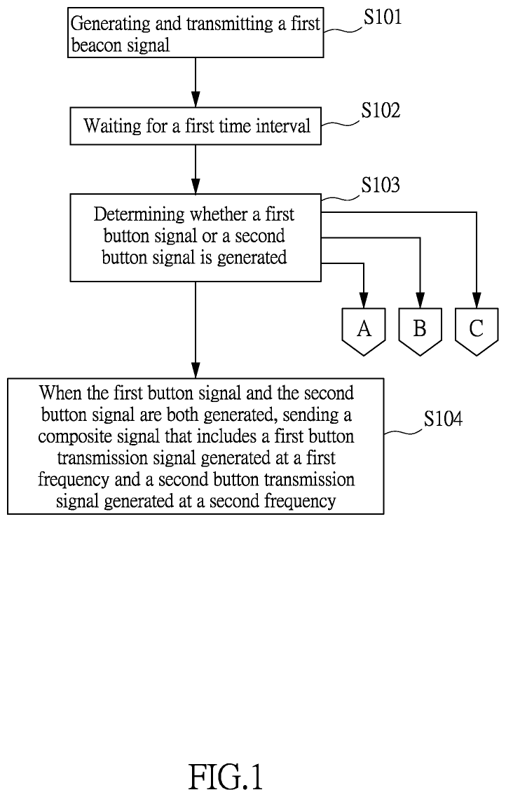

Please refer to FIG. 1 for the active stylus and the method of generating wireless signals thereof. The method is performed with an active stylus. The first preferred embodiment of the wireless signal generating method of the active stylus includes the following steps performed by the active stylus:
generating and transmitting a first beacon signal (S101);
waiting for a first time interval (S102);
determining whether a first button signal or a second button signal is generated (S103);
when it is determined that the first button signal and the second button signal are both generated, sending a composite signal that includes a first button transmission signal generated at a first frequency and a second button transmission signal generated at a second frequency (S104).

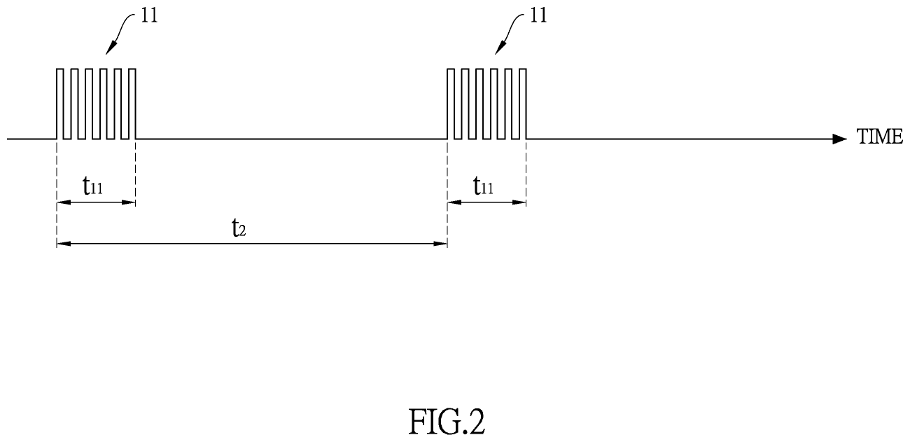

FIG. 2 explains the two beacon signals 11 sent at different times. The beacon signal 11 represents a signal at the beginning of a transmission period. In this preferred embodiment, the transmission time t₁₁ of the beacon signal 11 can be 1 millisecond (ms), and the transmission period t₂ can be 7.2 ms.

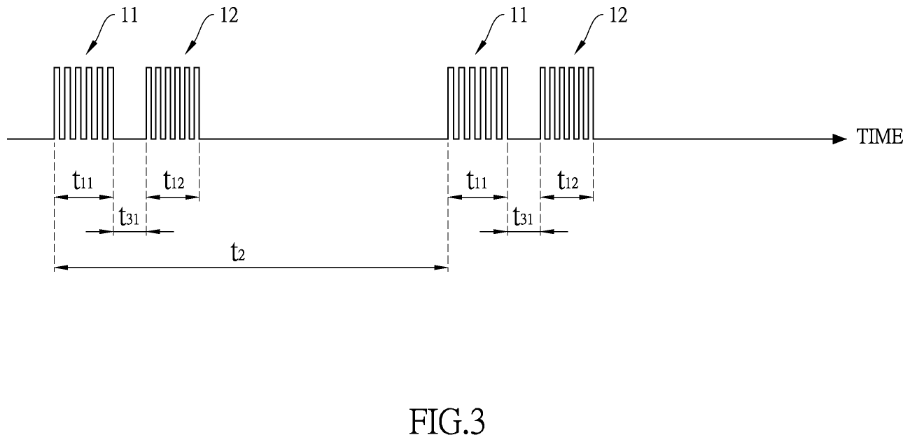

FIG. 3 further describes a composite signal 12 after each beacon signal 11. After the active stylus transmits the beacon signal 11, it waits for a first time interval t₃₁. When the first button signal and the second button signal are both generated, the composite signal 12 is sent. The composite signal 12 includes the first button transmission signal and the second button transmission signal. In this preferred embodiment, the first time interval t₃₁ is 0.032 ms, the first frequency is 18 KHz, and the second frequency is 31 KHz. The transmission time of the composite signal 12, t₁₂, which is the same as the transmission time t₁₁ of the beacon signal 11, is 1 ms.

The wireless signal generating method of the active stylus generates the first button transmission signal at the first frequency and generates the second button transmission signal at the second frequency, and transmits the composite signal 12 containing simultaneously the first button transmission signal and the second button transmission signal. When a receiving end, such as a tablet computer, receives the composite signal 12, the first button transmission signal and second button transmission signal contained in the composite signal 12 can be separated by filtering or Fourier transform because the first button transmission signal and the second button transmission signal are generated at different frequencies.

As a result, there is no need to transmit the first button transmission signal and the second button transmission signal at two separate transmission times. The composite signal 12 is transmitted only at one transmission time t₁. This can further save the overall time for transmitting the first button transmission signal and the second button transmission signal, thereby quickly transmitting the wireless signals.

For example, the active stylus is provided with a first button unit and a second button unit for performing different functions. When the first button unit is pressed, the stylus generates a first button signal. Similarly, when the second button unit is pressed, the active stylus generates a second button signal. In general, the user can directly use the active stylus to perform touch operations on the touch display panel of the receiving end, such as moving windows, clicking links, and so on. When the user presses the first button unit, the receiving end switches its mode. And the touch operation of the active stylus on the touch display panel of the receiving end becomes recording and displaying the user's handwriting. In short, the user is enabled to draw or record notes on the touch display panel of the receiving end. In addition, when the user presses the second button unit, the receiving end switches its mode again. In this case, the touch operation of the active stylus on the touch display panel of the receiving end becomes the function of removing the user's handwriting. In short, the user is enabled to use an eraser-like function to remove the notes. The invention thus provides a user-friendly environment for the user to quickly switch between recording notes and moving windows, and can quickly remove the mistaken notes to re-record.

In other words, the active stylus detects the pressing state of the first button unit and the second button unit of the active stylus in one transmission period, and generates a first button signal or a second button signal according to the detection result. For example, when the user presses the first button unit for more than one transmission period, the active stylus can detect that the first button unit is being pressed during a transmission period, and correspondingly generate the first button signal. However, since the transmission period is relatively short, e.g., 7.2 ms, as long as the user has pressed the first button unit, the time until the first button unit is released is substantially longer than the transmission period. As far as the user is concerned, it is not necessary to purposely press the first button unit for a long time. Similarly, when the user presses the second button unit, the same method is employed to determine whether the second button signal is generated.

That is, when the user simultaneously presses the first switch unit and the second switch unit continuously over the transmission period, the active stylus generates and transmits the composite signal. When the receiving end receives the composite signal, it means that the user simultaneously presses the first switch unit and the second switch unit. The receiving end can perform a specific operation according to the first button transmission signal and the second button transmission signal, such as turning on or off the touch panel of the receiving end.

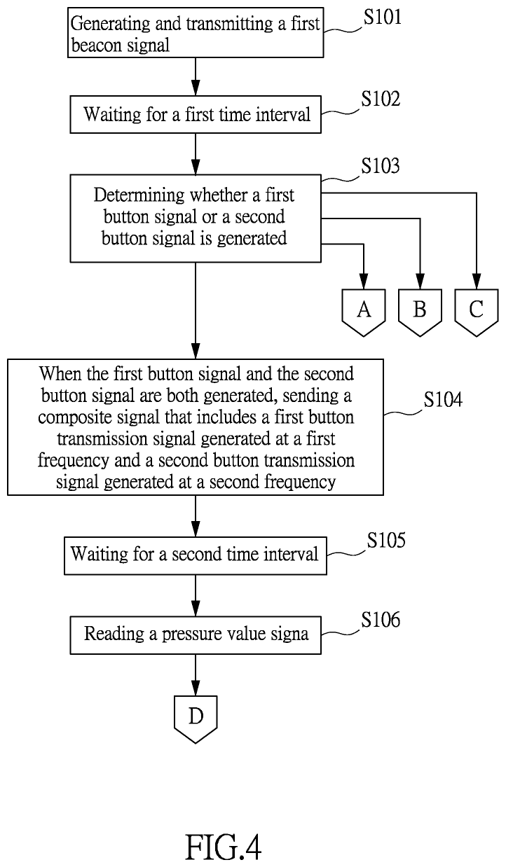

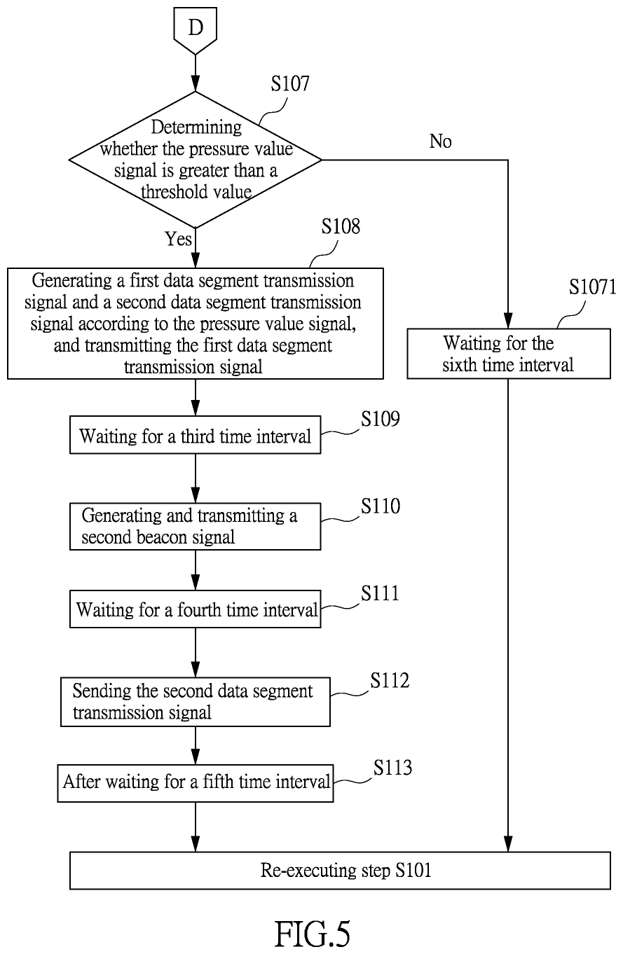

Please refer to FIG. 4 and FIG. 5. A second preferred embodiment of the method of generating wireless signals of the active stylus is the following. After the active stylus sends out the first button transmission signal and the second button transmission signal (S104), the active stylus further performs the following steps:
waiting for a second time interval (S105);
reading a pressure value signal (S106);
determining whether the pressure value signal is greater than a threshold value (S107);
when the pressure value signal is greater than the threshold value, generating a first data segment transmission signal and a second data segment transmission signal according to the pressure value signal, and transmitting the first data segment transmission signal (S108);
waiting for a third time interval (S109);
generating and transmitting a second beacon signal (S110);
waiting for a fourth time interval (S111);
sending the second data segment transmission signal (S112); and
after waiting for a fifth time interval (S113), re-executing step S101.

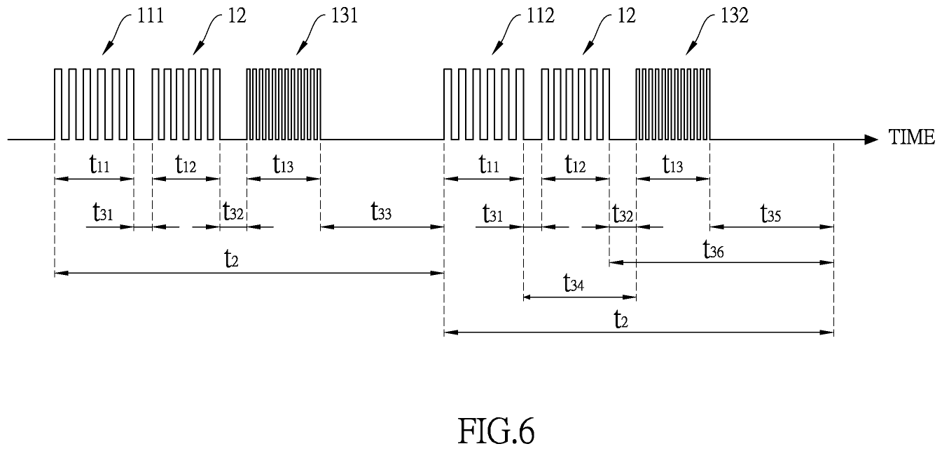

As shown in FIG. 6, after sending the first beacon signal 111, the active stylus waits for the first time interval. When the first button signal and the second button signal are both generated, the composite signal 12 is transmitted. After transmitting the composite signal 12, the active stylus further waits for the second time interval t₃₂, and then sends the first data segment transmission signal 131. In this preferred embodiment, the second time interval t₃₂ is 1.568 ms. Afterwards, the active stylus waits for the third time interval t₃₃ before transmitting the second beacon signal 112. The active stylus then waits for the fourth time interval t₃₄ to transmit the second data segment transmission signal 132. In the preferred embodiment, the first beacon signal 111 and the second beacon signal 112 are completely identical in content, and are only used to describe two consecutive beacon signals 11. The third time interval t₃₃ is 2.6 ms, and the fourth time interval t₃₄ is 2.6 ms. Finally, the active stylus further waits for the fifth time interval t₃₅ to resend the first beacon signal 111 (not shown). In the preferred embodiment, the fifth time interval t₃₅ is 2.6 ms. The transmission time t₁₃ of the first data segment transmission signal 131 and the second data segment transmission signal 132 is the same as the transmission time t₁₁ of the beacon signal 11, and is 1 ms. The method of generating the first and second data segment transmission signals 131, 132 will be described later.

Besides, as shown in FIG. 6, after transmitting the second beacon signal 112, the active stylus can repeatedly transmit the composite signal 12 before transmitting the second data segment transmission signal 132. That is, after sending the second beacon signal 112 and waiting for the first time interval t₃₁, the active stylus first repeatedly transmits the composite signal 12. After further waiting for the second time interval t₃₂, the active stylus then sends the second data segment sending signal 132. The transmission of the wireless signals is susceptible to influences of the external environment. Therefore, sometimes the receiving end may not receive the wireless signals. Repeatedly transmitting the composite signal 12 can greatly reduce the probability for the receiving end to miss the composite signal 12.

According to the wireless signal generating method of the active stylus, after the active stylus transmits the composite signal 12, it further reads the pressure value signal and determines whether the pressure value signal is greater than the threshold value. When the pressure value signal is greater than the threshold value, it indicates that the pressure value signal is valid. In other words, the user should be operating the active stylus to perform a touch operation. And the active stylus can sense the touch pressure that the user imposes on the active stylus. In short, it detects the writing force imposed by the user on the active stylus.

When the pressure value signal is greater than the threshold value, the active stylus generates the first data segment transmission signal 131 and the second data segment transmission signal 132 according to the pressure value signal. The active stylus sends the first data segment transmission signal 131 and the second data segment transmission signal 132 in two consecutive transmission periods. In the first transmission period, i.e., after the first beacon signal 111 is sent, the first data segment transmission signal 131 is transmitted. In the next transmission period, i.e., after the second beacon signal 112 is sent and waiting for the fourth time interval t₃₄, the second data segment transmission signal 132 is transmitted. In this way, the invention transmits a higher resolution pressure value signal.

The pressure value signal is generated according to the operating condition of the user, and the magnitude of the writing force as the user operates the active stylus varies a lot. Therefore, if only the low-resolution pressure value signal is transmitted, the receiving end will not be able to accurately obtain the accurate writing force of the user imposed on the active stylus. This can limit applications of the active stylus, such as imitating the writing using a soft pen.

The wireless signal generating method of the active stylus divides the pressure value signal into two data segment transmission signals and transmits them in two consecutive transmission periods. In this way, the pressure value signal is divided into two parts for transmission. After the receiving end receives the first data segment transmission signal and the second data segment transmission signal, the first data segment transmission signal and the second data segment transmission signal are combined into the pressure value signal, thereby obtaining a high-resolution pressure value signal and enabling more applications.

For example, the pressure value signal is a 12-bit data. The wireless signal generating method of the active stylus generates a first data segment using the first 8 bits of the pressure value signal, and generates a second data segment using the last 4 bits of the pressure value signal.

The active stylus generates the first data segment transmission signal at a specific frequency according to the value of the first data segment, and generates the second data segment transmission signal at another specific frequency according to the value of the second data segment. That is, each value of the first data segment corresponds to a specific frequency, and each value of the second data segment also corresponds to a specific frequency. When the receiving end receives the first data segment transmission signal or the second data segment transmission signal, the receiving end calculates the value of the first data segment or the second data fragment by looking up a table according to the frequency of the received signal.

For example, suppose the value of the first data segment is 00000001. The active stylus generates the first data segment transmission signal at the frequency of 15652 Hz. When the value of the first data segment is 00000010, the active stylus generates the first data segment transmission signal at the frequency of 15679 Hz. In addition, when the value of the second data segment is 0001, the active stylus generates the second data segment transmission signal at the frequency of 28301 Hz. When the value of the second data segment is 0010, The active stylus generates the second data segment transmission signal at the frequency of 28571 Hz.

In the preferred embodiment, the first data segment transmission signal and the second data segment transmission signal are distributed in different frequency bands.

Since the first data segment transmission signal and the second data segment transmission signal are distributed in different frequency bands, when receiving a wireless signal, the receiving end can directly use the frequency value of the wireless signal to determine which frequency band is used for the wireless signals, and immediately confirm whether the wireless signal is the first data segment transmission signal or the second data segment transmission signal.

Therefore, even if the first data segment transmission signal and the second data segment transmission signal are transmitted in different transmission periods, there is no need to determine the order of the transmission period. It is straightforward to use the frequency value to determine whether it is the data segment transmission signal or the second data segment transmission signal. The receiving end only needs to receive signals in two consecutive transmission periods in order to reproduce the complete pressure value signal. Therefore, the processing efficiency of signal determination can be further improved.

When the receiving end receives the first data segment transmission signal and the second data segment transmission signal, the frequency values of the first data segment transmission signal and the second data segment transmission signal can be determined through Fourier transform. With the frequency values, the first data segment transmission signal and the second data segment transmission signal are converted to obtain the first data segment and the second data segment. The receiving end then further uses the values of the first data segment and the second data segment to reproduce the pressure value signal.

For example, suppose the frequency of the first data segment transmission signal received by the receiving end is 15679 Hz. The value of the first data segment can be calculated as 00000010. When the frequency of the second data segment transmission signal received by the receiving end is 28571 Hz, the value of the second data segment can be calculated as 0010. The receiving end can thus integrate the value of the first data segment and the value of the second data segment to form the value of the pressure value signal as 000000100010.

That is, the pressure value signal has 4096 different possible values. Therefore, the writing force imposed by the user on the active stylus can be divided into 4096 different values. Such a value can be accurately sent to the receiving end. The receiving end analyzes and determines the writing force imposed by the user on the active stylus.

Furthermore, the active stylus determines whether the pressure value signal is greater than a threshold value (S107). When the active stylus determines that the pressure value signal is not greater than the threshold value, the active stylus waits for the sixth time interval (S1071) and performs step S101 again.

When the pressure value signal is not greater than the threshold value, it means that the user is not operating the stylus. The pressure signal generated at this time should be a false positive. The active stylus thus does not do any action. After a wait of the sixth time interval, the wireless signal generating method of the active stylus is re-executed.

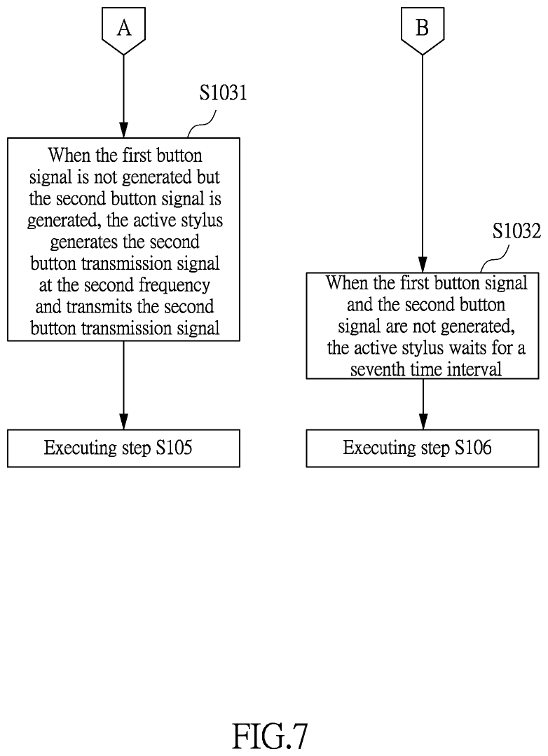

Referring to FIG. 7, when the active stylus determines that the first button signal is not generated but the second button signal is generated, the active stylus generates the second button transmission signal at the second frequency (S1031) and transmits the second button transmission signal. After transmitting the second button transmission signal, step S105 is performed.

Besides, when the active stylus determines that the first button signal and the second button signal are not generated, the active stylus waits for a seventh time interval (S1032), and performs step S106.

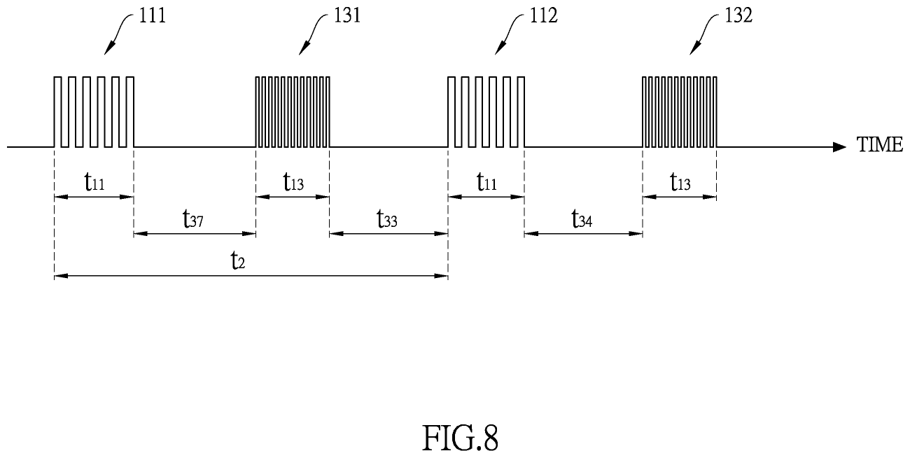

As shown in FIG. 8, after the active stylus sends the first beacon signal 111 and determines that the first button signal and the second button signal are not generated, the active stylus waits for the seventh time interval t₃₇ before transmitting the first data segment transmission signal 131. In the preferred embodiment, the seventh time interval t₃₇ is 2.6 ms. Afterwards, the active stylus waits for the third time interval t₃₃ to transmit the second beacon signal 112, and waits for the fourth time interval t₃₄ to transmit the second data segment transmission signal 132. Finally, the active stylus further waits for the fifth time interval t₃₅ to resend the first beacon signal 111 (not shown).

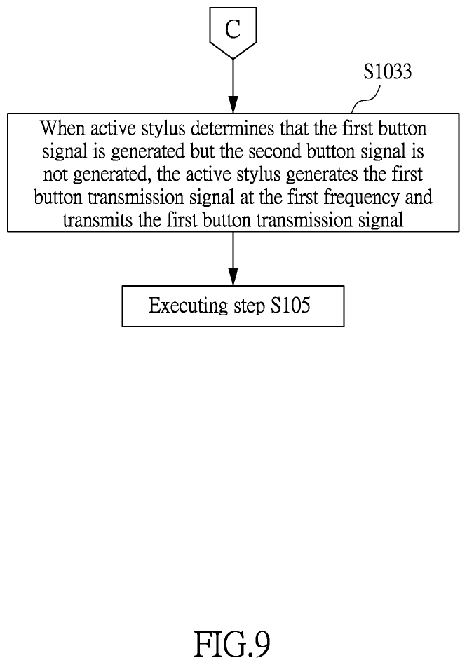

Furthermore, as shown in FIG. 9, when the active stylus determines that the first button signal is generated but the second button signal is not generated, the active stylus generates the first button transmission signal at the first frequency and transmits the first button transmission signal (S1033). After transmitting the first button transmission signal, step S105 is performed.

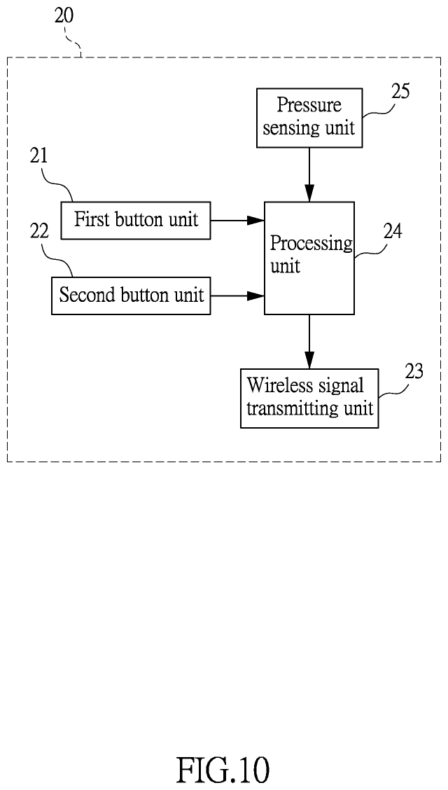

As shown in FIG. 10, the active stylus 20 includes a first button unit 21, a second button unit 22, a wireless signal transmitting unit 23, and a processing unit 24. The first button unit 21 is configured to generate a first button signal. The second button unit 22 is configured to generate a second button signal. For example, the first button unit 21 and the second button unit 22 can be physical buttons on the active stylus 20.

The processing unit 24 is electrically connected to the first button unit 21, the second button unit 22, and the wireless signal transmitting unit 23. The processing unit 24 generates a first beacon signal and passes the wireless signal. The transmitting unit 23 transmits the first beacon signal.

After the processing unit 24 sends the first beacon signal, the processing unit 24 waits for a first time interval, and determines whether a first button signal generated by the first button unit 21 or a second button signal generated by the second button unit 22 is received.

When the processing unit 24 receives the first button signal and the second button signal, the processing unit 24 sends a composite signal. The composite signal includes a first button transmission signal generated at a first frequency and a second button transmission signal generated at a second frequency.

The active stylus generates the first button transmission signal using the first frequency and generates the second button transmission signal using the second frequency, and simultaneously sends the first button transmission signal and the second button transmission signal. Suppose a receiving end, such as a tablet computer, receives the first button transmission signal and the second button transmission signal. Since the first button transmission signal and the second button transmission signal have different frequencies, filtering or Fourier transform can separate the simultaneously sent first button transmission signal and second button transmission signal.

As a result, even if the first button transmission signal and the second button transmission signal are simultaneously sent, the receiving end can readily separate the first button transmission signal and the second button transmission signal. Moreover, the first button transmission signal and the second button transmission signal are sent simultaneously without the need to send them at different times. Therefore, the invention saves the overall transmitting time of sending the first button transmission signal and the second button transmission signal. This method enables quick wireless signal transmissions.

The active stylus further includes a pressure sensing unit 25 for generating a pressure value signal and electrically connected to the processing unit 24. After the processing unit 24 transmits the composite signal, the processing unit 24 waits for a second time interval and reads the pressure value signal. The processing unit 24 determines whether the pressure value signal is greater than a threshold value.

When the processing unit 24 determines that the pressure value signal is greater than the threshold value, the processing unit 24 generates a first data segment transmission signal and a second data segment transmission signal according to the pressure value signal. The processing unit 24 then transmits the first data segment transmission signal via the wireless signal transmitting unit 23.

After the processing unit 24 sends out the first data segment transmission signal, the processing unit 24 waits for a third time interval, and generates a second beacon signal. The processing unit 24 transmits the second beacon signal via the wireless signal transmitting unit. 23.

After sending the second beacon signal, the processing unit 24 waits for a fourth time interval and sends the second data segment transmission signal. After waiting for a fifth time, the processing unit 24 regenerates the first beacon signal. In the preferred embodiment, the first data segment transmission signal and the second data segment transmission signal are distributed in different frequency bands.

The functions and principle of the pressure value signal have been described in the wireless signal generating method of the active stylus, and therefore will not be repeated herein.

When the processing unit 24 determines that the pressure value signal is not greater than the threshold, the processing unit 24 waits for a sixth time interval and regenerates the first beacon signal.

When the processing unit 24 does not receive the first button signal but receives the second button signal, the processing unit 24 generates the second button transmission signal at the second frequency, and sends the second button transmission signal through the wireless signal transmitting unit 23. Moreover, the processing unit 24 waits for the second time interval, reads the pressure value signal, and determines whether the pressure value signal is greater than the threshold value.

When the processing unit 24 does not receive the first button signal and the second button signal, the processing unit 24 waits for a seventh time interval to read the pressure value signal. The processing unit 24 then determines whether the pressure value signal is greater than the threshold value.

When the processing unit 24 receives the first button signal but not the second button signal, the processing unit 24 generates the first button transmission signal at the first frequency, and sends the first button transmission signal through the wireless signal transmitting unit 23. The processing unit 24 waits for the second time interval, reads the pressure value signal, and determines whether the pressure value signal is greater than the threshold value.

While the invention has been described by way of examples and in terms of the preferred embodiments, it is to be understood that the invention is not limited to the embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A wireless signal generating method of an active stylus, the method executed by an active stylus and comprising steps of:
a. generating and transmitting a first beacon signal;
b. waiting for a first time interval;
c. determining whether a first button signal or a second button signal is generated;
d. when it is determined that the first button signal and the second button signal are not generated, waiting for a seventh time interval;
e. reading a pressure value signal;
f. determining whether the pressure value signal is greater than a threshold value;
g. when the pressure value signal is greater than the threshold value, generating a first data segment transmission signal and a second data segment transmission signal and transmitting the first data segment transmission signal;
h. waiting for a third time interval;
i. generating and transmitting a second beacon signal;
j. waiting for a fourth time interval;
k. transmitting the second data segment transmission signal; and
l. waiting for a fifth time interval and re-executing the step a.

2. The method as claimed in claim 1, wherein the first data segment transmission signal and the second data segment transmission signal are in different frequency bands.

3. The method as claimed in claim 1 further comprising the step of: when the pressure value signal is not greater than the threshold value, waiting for a sixth time interval and re-executing the step a.

4. The method as claimed in claim 1 further comprising the steps of: when the first button signal is not generated while the second button signal is generated, generating the second button transmission signal at a second frequency and transmitting the second button transmission signal; waiting for a second time interval; and executing step e.

5. The method as claimed in claim 1 further comprising the steps of: when the first button signal and the second button signal are both generated, generating a composite signal containing the first button transmission signal at a first frequency and the second button transmission signal at a second frequency; waiting for a second time interval; and executing the step e.

6. The method as claimed in claim 1 further comprising the steps of: when the first button signal is generated while the second button signal is not generated, generating the first button transmission signal at a first frequency and transmitting the first button transmission signal; waiting for a second time interval; and executing step e.

7. An active stylus, comprising:
a first button unit for generating a first button signal;
a second button unit for generating a second button signal;
a wireless signal transmitting unit;
a processing unit, electrically connected to the first button unit, the second button unit, and the wireless signal transmitting unit, for generating a first beacon signal and transmitting the first beacon signal via the wireless signal transmitting unit; and
a pressure sensing unit for generating a pressure value signal and electrically connected to the processing unit;
wherein after transmitting the first beacon signal, the processing unit waits for a first time interval and determines whether the first button signal generated by the first button unit or the second button signal generated by the second button unit is received;
when the processing unit does not receive the first button unit and the second button signal, the processing unit waits for a seventh time interval, reads the pressure value signal, and determines whether the pressure value signal is greater than a threshold value;
when the pressure value signal is determined to be greater than a threshold value, the processing unit generates a first data segment transmission signal and a second data segment transmission signal according to the pressure value signal, and transmits the first data segment transmission signal via the wireless signal transmitting unit;
after transmitting the first data segment transmission signal, the processing unit waits for a third time interval to generate a second beacon signal and transmits the second beacon signal via the wireless signal transmitting unit; and
after transmitting the second data segment transmission signal, the processing unit waits for a fourth time interval to transmit the second data segment transmission signal, waits for a fifth time interval, and re-generate the first beacon signal.

8. The active stylus as claimed in claim 7, wherein the first data segment transmission signal and the second data segment transmission signal are in different frequency bands.

9. The active stylus as claimed in claim 7, wherein when the pressure value signal is determined to be not greater than the threshold value, the processing unit waits for a sixth time interval and re-generates the first beacon signal.

10. The active stylus as claimed in claim 7, wherein
when the processing unit does not receive the first button signal while receives the second button signal, the processing unit generates the second button transmission signal at a second frequency and transmits the second button transmission signal via the wireless signal transmitting unit, waits for the second time interval, reads the pressure value signal, and determines whether the pressure value signal is greater than a threshold value;
when the processing unit determines the pressure value signal to be greater than the threshold value, the processing unit generates a first data segment transmission signal and a second data segment transmission signal, and transmits the first data segment transmission signal via the wireless signal transmitting unit;
after the processing unit transmits the first data segment transmission signal, the processing unit waits for a third time interval and generates a second beacon signal, and transmits the second beacon signal via the wireless signal transmitting unit; and
after the processing unit transmits the second data segment transmission signal, the processing unit waits for a fourth time interval and generates the second data segment transmission signal, and then waits for a fifth time interval and re-generate the first beacon signal.

11. The active stylus as claimed in claim 7, wherein
when the processing unit receives the first button signal and the second button signal, the processing unit generates a composite signal containing a first button transmission signal generated at a first frequency and a second button transmission signal generated at a second frequency;
after the processing unit transmits the composite signal, the processing unit waits for a second time interval, reads the pressure value signal, and determines whether the pressure value signal is greater than the threshold value;
when the processing unit determines that the pressure value signal is greater than the threshold value, the processing unit generates the first data segment transmission signal and the second data segment transmission signal according to the pressure value signal, and transmits first data segment transmission signal via the wireless signal transmitting unit; and
after the processing unit transmits the first data segment transmission signal, the processing unit waits for the third time interval and generates the second beacon signal, and then transmits the second beacon signal via the wireless signal transmitting unit; and
after the processing unit transmits the second beacon signal, the processing unit waits for a fourth time interval and transmits the second data segment transmission signal, and then waits for a fifth time interval and re-generate the first beacon signal.

12. The active stylus as claimed in claim 7, wherein
when the processing unit receives the first button signal but not the second button signal, the processing unit generates the first button transmission signal at the first frequency and transmits the first button transmission signal via the wireless signal transmitting unit, waits for the second time interval, reads the pressure value signal, and determines whether the pressure value signal is greater than a threshold value;
when the processing unit determines the pressure value signal to be greater than the threshold value, the processing unit generates a first data segment transmission signal and a second data segment transmission signal, and transmits the first data segment transmission signal via the wireless signal transmitting unit;
after the processing unit transmits the first data segment transmission signal, the processing unit waits for a third time interval and generates a second beacon signal, and transmits the second beacon signal via the wireless signal transmitting unit; and
after the processing unit transmits the second data segment transmission signal, the processing unit waits for a fourth time interval and generates the second data segment transmission signal, and then waits for a fifth time interval and re-generate the first beacon signal.
